(19) United States
(12) Patent Application Publication
(10) Pub. No.: US 2003/0033241 A1
(43) Pub. Date: Feb. 13, 2003

(54) Methods and systems for automated loan origination, processing and approval

(76) Inventor: Adi Harari, Beverly Hills, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/928,036

(22) Filed: Aug. 8, 2001

(51) Int. Cl. G06F 17/60

(52) U.S. Cl. 705/38

(57) ABSTRACT

A method for loan origination, processing and closing, using a network based system including a server system coupled to a centralized database and at least one client system is disclosed. The method includes establishing a business relationship pertaining to a loan transaction between a broker and a lender, defining a division of labor, providing forms and informational notices to the broker, and maintaining the task list to ensure that the broker has complied with state and federal regulations. Other embodiments of the invention utilize a System, a Computer Program embodied on a computer readable medium, a Computer, and a Database to manage the loan processing and improve operational efficiency of the business entity.

### CROSS REFERENCE TO RELATED APPLICATIONS

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to loan origination, processing and approval and more particularly to processing real estate loans using a division of labor between brokers and lenders.

A large number of real estate loans are processed by lenders or lenders' agents. These loans are processed either by traditional banks or mortgage bankers/brokers all specializing in processing loans in compliance with various state and federal regulations. Once the loan is processed, the loan is funded and the transaction is closed.

Often, a real estate transaction is consummated between a buyer and a seller utilizing a broker or a broker's agent, or an attorney. The real estate transaction normally involves various parties, including, but not limited to, a buyer, a seller, a real estate broker, an escrow officer, a lender and a lender's agent (also known as a loan agent). An important aspect of the real estate transaction relates to applying and obtaining a suitable real estate loan from a lender at a favorable rate.

Once a purchase agreement or a contract is signed between the buyer and the seller, the buyer obtains for a loan based on the buyer's credit, income and the value of the property. Various steps are undertaken by the buyer in obtaining the loan. The loan agent of the lender helps the buyer in filling out the loan application and identifying a list of documents needed by the lender to process the loan. Once the documents are submitted by the buyer through a loan agent, the lender evaluates the buyer's creditworthiness by running a credit report as well as verifying other financial information. The lender also obtains an appraisal report on the property that is purchased by the buyer to ensure that there is a sufficient collateral value in the property. Once the loan is approved, the loan is funded and the transaction is closed.

Often, the loan agent enters the transaction after the purchase agreement has been executed between the buyer and the seller. The loan agent helps the buyer to complete the loan application and processes the same with the lender. However, the loan agent, not being familiar with the buyer, adds complications to the transaction which often leads to the loan not closing. At times, the real estate broker, who has already earned the trust of the buyer, is in the best position to undertake loan origination and processing related activities to aid in closing the transaction. However, real estate brokers are generally not permitted to engage in such activities for compensation because of various laws, rules, and regulations associated with compensation related to funding loans for real property. Furthermore, real estate brokers lack the technical knowledge to process the loan independently, since they are primarily responsible for sales activities. In addition, there are various other disclosure issues affecting the transaction that prohibit lenders to allow real brokers participation in loan origination, processing and funding activities.

### BRIEF SUMMARY OF THE INVENTION

The present invention provides in some aspects, a system and method for providing for a division of labor in funding loans for real property and systems and methods for tracking the funding of such loans to allow person without prior training to originate loans. In an exemplary embodiment, the invention is an integrated network based system, which organizes a company's experiences, operating procedures, best practices, information sources, competitive information and analytical tools on a server for easy storage and retrieval. The invention is a method and a system to manage real estate loans and provide status of the real estate loans to all involved parties including, but not limited to, a mortgage broker, a real estate broker, salesperson, and escrow officer. The information provided over the web is the real time information and the newly added information is updated and processed on a continuous basis. The objective is to increase the profitability of a business entity in loan origination and processing while facilitating the ongoing loan processing operations with the help of a real estate broker who assisted the buyer to enter into the real estate transaction.

In an exemplary embodiment, the present invention provides a method for loan origination, processing and approval. The method is practiced utilizing a network based system. The method comprises establishing a business relationship pertaining to a loan transaction between a broker and a lender through legal agreements, defining a division of labor through a task list, providing forms and informational notices in support of the task list, and tracking the task list to ensure that the broker has complied with the task list. The method further ensures that the tasks are completed in order to comply with state laws and governing agencies regulations qualify for fee income. The method further provides that a Mortgage Broker Agreement and a Borrower Disclosure have been executed by the broker.

Furthermore, the method defines a division of labor by identifying the broker responsibility for various tasks. Some of the tasks defined as broker's responsibility includes, reviewing buyer's financial goals, reviewing buyer's assets, reviewing available loan programs, reviewing tax returns, income statements, credit review, taking information from borrower and completing borrower worksheet online, selecting an appropriate loan program, collecting documentation, photocopying original documents, sending documentation copy to processing department, opening escrow, completing escrow opening instruction form, ordering a title report, completing order form, faxing to escrow the order form with statement of information and insurance information if applicable, scheduling and meeting the appraiser for an inspection, maintaining contact with borrower, realtors, and lender, to apprise them of the status of the application and to gather additional information, locking the rate with the client, if necessary, preparing rate lock action sheet processing, arranging time for document signing, and attending loan closing.

In another exemplary embodiment, the invention provides a system to implement the process for managing real estate loans in compliance with state and federal regulations for the purpose of qualifying for fee income. The system includes a computer, and at least one server connected via a network to the computer. The system is configured to develop and track a task list to implement a division of labor between a broker and a lender relating to activities resulting in funding of a loan for the real property transaction, provide an indication to a party responsible for the task on the task list, process an approval of the loan after certain tasks on the task list are completed and regulatory requirements are satisfied, and issue a commission check to the broker upon funding of the loan and closing of the real property transaction.

In yet another exemplary embodiment of the invention, the invention provides a computer to facilitate online processing and approval of loans. The computer is programmed to receive loan transaction information in to a centralized database, store the loan transaction information into various subsections of the centralized database and cross reference the loan transaction information against a borrower identification for easy retrieval and update, evaluate the loan transaction based on pre-determined criteria, and generate management reports to track the loan transaction.

In yet further exemplary embodiment, the invention provides a computer program embodied on a computer readable medium. The computer program comprises a code segment that registers a broker with a lender to process a loan transaction, provides a list of tasks and targeted completion dates to the broker based on an anticipated closing date of the loan transaction, tracks the list against the targeted completion dates to complete the task, updates the task list as the tasks are completed, generates loan documents after the loan transaction has been approved, and generates a commission check to the broker after the loan documents are executed and the loan transaction is closed.

In yet another exemplary embodiment, a centralized database to organize real estate transaction loan details is disclosed. The database comprises data corresponding to various transactions, transactions status and action lists associated with various transactions, data corresponding to various mortgage programs with at least one of associated referenced numbers, a starting rate and an ending rate, margin, client points, maximum loan to value ratio and other pertinent information, and data corresponding to contact information regarding parties to various transactions. The data within the database is cross-referenced for easy retrieval, update and storage.

### BRIEF DESCRIPTION OF THE DRAWINGS

FIG. 1 is an exemplary embodiment of a flow chart of a Business Process between a broker and a lender;

FIG. 2 is a block diagram of a Loan Processing System (LPS);

FIG. 3 is an expanded version block diagram of an exemplary embodiment of a server architecture of the LPS;

FIG. 4 illustrates a configuration of a database within a database server of the server system shown in FIG. 2;

FIG. 5 is an exemplary embodiment of a hardware architecture diagram of a general purpose computer suitable for use as a server host;

FIG. 6 is an exemplary embodiment of a Realtor Registration Process flowchart in accordance with the present invention;

FIG. 7 is an exemplary embodiment of a flowchart depicting a Business Process Flow;

FIG. 8 is an exemplary embodiment of a home page welcoming the user to the GoLoan.com business web site;

FIG. 9 is an exemplary embodiment of a web-based screen providing the information to the user regarding a specific loan transaction;

FIG. 10 is an exemplary embodiment of report downloaded by the LPS system for a specific employee;

FIG. 11 is an exemplary embodiment of a mortgage rates report downloaded by the LPS to provide detail rate information to various brokers that are registered to use the LPS system; and

FIGS. 12 and 13 are exemplary embodiments of a Mortgage Loan Procedures & Broker Certification Report downloaded by the LPS system, which need to be completed and submitted by the broker before any commission is paid to the broker.

### DETAILED DESCRIPTION OF THE INVENTION

Exemplary embodiments of systems and processes that facilitate integrated network-based electronic reporting and workflow process management related to a Loan Processing System (LPS) are described below in detail. The systems and processes facilitate, for example, electronic submission of information using a client system, automated extraction of information, and web-based origination, processing, tracking and approval of real estate loans.

The systems and processes are not limited to the specific embodiments described herein. In addition, components of each system and each process can be practiced independent and separate from other components and processes described herein. Each component and process also can be used in combination with other components and processes.

In an exemplary embodiment, the application is implemented as a Centralized Database utilizing a Structured Query Language (SQL) with a client user interface front-end for administration and a web interface for standard user input and reports. The application is web enabled and runs on a business entity's intranet. In a further exemplary embodiment, the application is fully accessed by individuals having authorized access outside the firewall of the business entity through the Internet. In another exemplary embodiment, the application is run in a Windows NT environment or simply on a stand alone computer system. In yet another exemplary embodiment, the application is practiced through manual process steps. The application is flexible and designed to run in various different environments without compromising any major functionality.

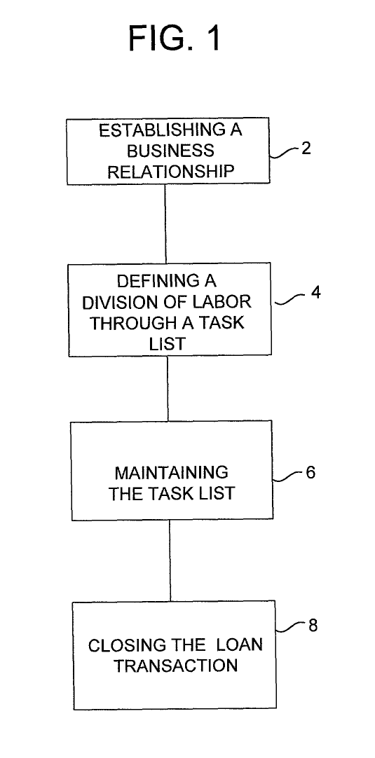

FIG. 1 is an exemplary embodiment of a flow chart of a Business Process between a broker and a lender. The business process for loan origination, processing and approval, in one embodiment, utilizes a network based system, a centralized database and a client system. The process includes establishing 2 a business relationship pertaining to a loan transaction between a broker and a lender through legal agreements. The process further includes defining 4 a division of labor through a task list between the broker and the lender to assist in the performance of the legal agreements. The process includes maintaining 6 the task list to ensure that the broker had fulfilled his assigned responsibilities. In an exemplary embodiment, the lender maintains the task list. In yet another embodiment, the broker maintains the task list. It is also feasible that a third party may maintain the task list for the broker or the lender for a small fee. The process further includes closing 8 the loan transaction which relates to distributing loan proceeds, commissions, other payments and funds, preparing accounting of funds/closing documents, and distributing documents to appropriate parties.

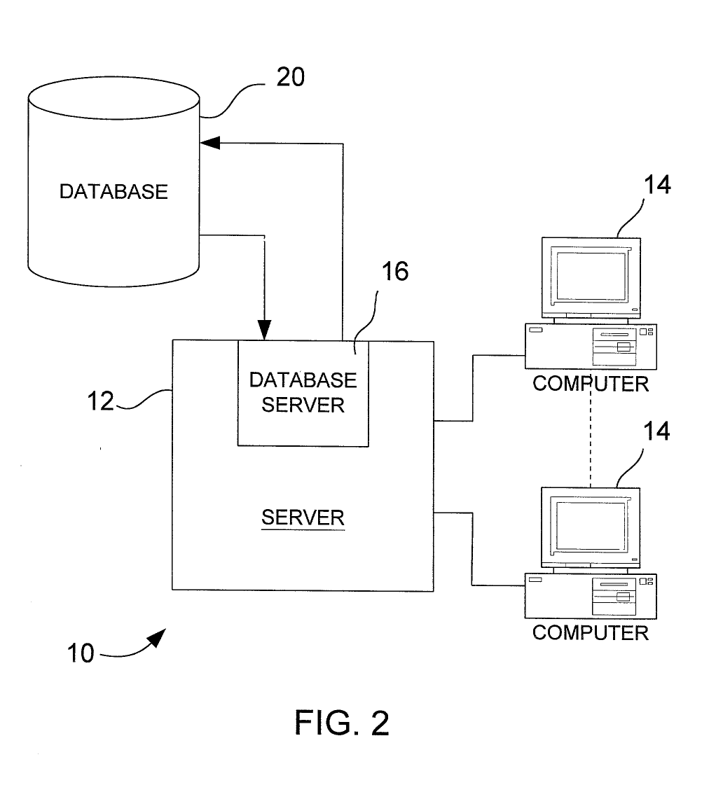

FIG. 2 is a block diagram of a LPS 10 that includes a server system 12, sometimes referred to herein as server 12, and a plurality of customer devices 14 connected to server 12. LPS 10 is implemented for origination, processing and approval of various types of loans. LPS 10 utilizes several pre-defined loan decision criteria and checklists in performing the loan analysis. The loan decision criteria and checklists, and various other business tools and processes, as described below in more detail, are stored on server 12 and can be accessed by a requester at any one of customer devices 14.

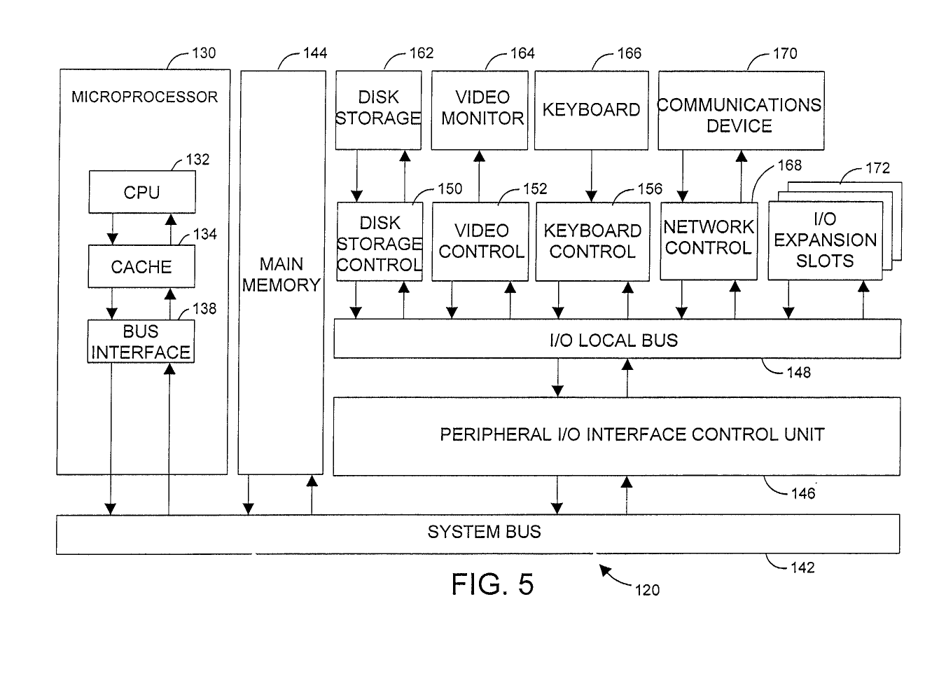

In one embodiment, devices 14 are general purpose computers including a web browser, and server 12 is accessible to devices 14 via a network such as an intranet or a wide area network such as the Internet. FIG. 5 below describes the general purpose computer 14 in detail. In an alternative embodiment, devices 14 are servers for a network of customer devices. Customer device 14 could also be any client system capable of interconnecting to the Internet including a web-based digital assistant, a web-based phone or other web-based connectable equipment. In another embodiment, server 12 is configured to accept information over a telephone, for example, at least one of a voice responsive system where a user enters spoken data, or by a menu system where a user enters a data request using the touch keys of a telephone as prompted by server 12.

Devices 14 are interconnected to the network, such as a local area network (LAN) or a wide area network (WAN), through many interfaces including dial-in-connections, cable modems and high-speed lines. Server 12 includes a database server 16 connected to a centralized database 20. In one embodiment, centralized database 20 is stored on database server 16 and is accessed by potential customers at one of customer devices 14 by logging onto server system 12 through one of customer devices 14. In an alternative embodiment, centralized database 20 is stored remotely from server 12.

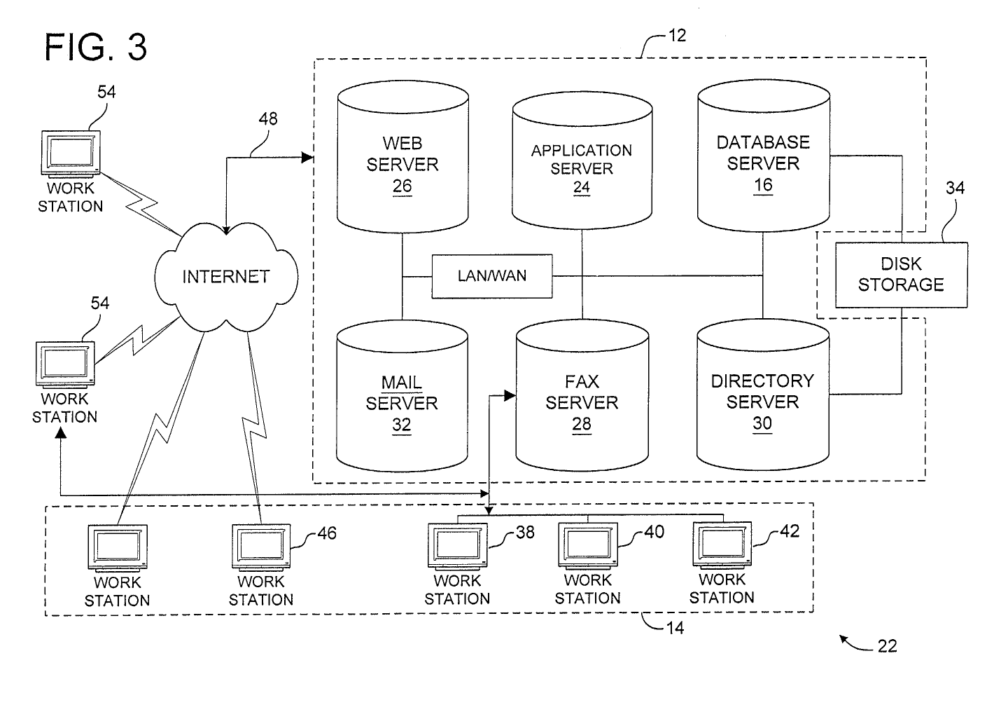

FIG. 3 is an expanded version block diagram of an exemplary embodiment of a server architecture of a LPS 22. LPS 22 is implemented for the complex environment. Components in LPS 22, identical to components of system 10 (shown in FIG. 2), are identified in FIG. 3 using the same reference numerals used in FIG. 2. LPS 22 includes server system 12 and customer devices 14. Server system 12 includes, but not limited to, a database server 16, an application server 24, a web server 26, a fax server 28, a directory server 30, and a mail server 32.

Servers are often dedicated, meaning that they perform no other tasks besides their server tasks. For example, application server 24 serves various applications and modules associated with the computer program applications to users and also act as a traffic officer in a database intensive application such as this. Web server 26 hosts the web site using one of the multi-platform servers. Fax server 28 sends and receives faxes with an internet server. This helps business keeping costs low and saves paper. Directory server 30 manages various directories and sub directories to organize information. Mail server 32 sets up a messaging system that allows the users to exchange e-mails over LANs and/or the Internet. In yet another embodiment, there are other servers such as an Audio/Video server to deliver streaming multi-media content, a List server to create and serve individualized mailing lists and e-mail response system for users, customer, or affiliates, and Chat servers are utilized.

A disk storage unit 34 is coupled to database server 16 and directory server 30. Servers 16, 24, 26, 28, 30, and 32 are coupled in a local area network (LAN) 36. Additionally, workstations 38, 40, and 42 are coupled to LAN 36. Alternatively, workstations 38, 40, and 42 are coupled to LAN 36 via an Internet link or are connected through an intranet. Workstations 38, 40, and 42 are used by a system administrator, a loan processing clerk and a loan approval manager, respectively.

Each workstation 38, 40, and 42 is a personal computer including a web browser. Although the functions performed at the work stations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals or employees and to third parties, e.g., a real estate broker 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee or a real estate broker having a workstation 52 can access server system 12. One of customer devices 14 includes workstations 54 located at a remote location. Workstations 54 are personal computers including a web browser. Also, workstations 54 are configured to communicate with server system 12. Furthermore, fax server 28 communicates with employees and real estate brokers 46 located outside the business entity and any of the remotely located systems, via a telephone link.

The systems described in FIGS. 2 and 3 are configured to implement a methodology to process and approve loans in compliance with state and federal regulations with the aid of a real estate broker and analyze loans based on pre-determined criteria and methodology.

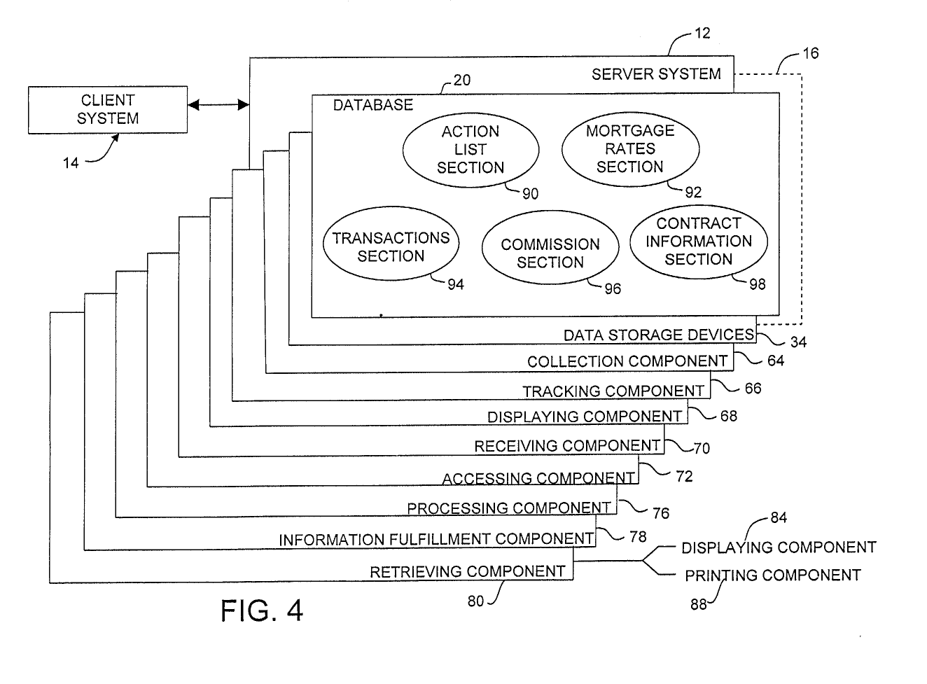

FIG. 4 shows a configuration of database 20 within database server 16 of server system 12 shown in FIG. 2. Database 20 is coupled to several separate components within server system 12. These separate components perform specific tasks as required to achieve the system functionality.

Server system 12 includes a collection component 64 for collecting information from users into centralized database 20, a tracking component 66 for tracking information, a displaying component 68 to display information, a receiving component 70 to receive a specific query from client system 14, and an accessing component 72 to access centralized database 20. Receiving component 70 is programmed for receiving a specific query from one of a plurality of users. Server system 12 further includes a processing component 76 for searching and processing received queries against data storage device 34 containing a variety of information collected by collection component 64. An information fulfillment component 78, located in server system 12, downloads the requested information to the plurality of users in the order in which the requests were received by receiving component 70. Information fulfillment component 78 downloads the information after the information is retrieved from data storage device 34 by a retrieving component 80. Retrieving component 80 retrieves, downloads and sends information to client system 14 based on a query received from client system 14 regarding various alternatives.

Retrieving component 80 further includes a display component 84 configured to download information to be displayed on a client system's graphical user interface and a printing component 88 configured to print information. Retrieving component 80 generates various reports requested by the user through client system 14 in a pre-determined format. System 10 is flexible to provide alternative reports and is not constrained to the options set forth above.

In an exemplary embodiment, database 20 is divided into an Action List Section (ALS) 90, a Mortgage Rates Section (MRS) 92, a Transactions Status Section (TSS) 94, a Commission Section (CS) 96, and a Contact Information Section (CIS) 98. For example ALS 90 includes action items segregated by each transaction as it relates to a specific borrower. MRS 92 includes information about various mortgage plans available with associated referenced numbers, a starting rate and an ending rate, margin, client points, maximum loan to value ratio and other pertinent information. TSS 94 includes current status of each transaction. CS 96 includes the current summary of commission by each broker or each office. CIS 98 includes information about contact information as it relates to each borrower and each transaction. Sections 90, 92, 94, 96 and 98 within database 20 are interconnected to update and retrieve the information as required. Each Section is further divided into several individualized sub-sections to store data in various different categories.

FIG. 5 is an exemplary embodiment of a hardware architecture 120 diagram of a general purpose computer suitable for use as a server host. A microprocessor 130, comprised of a Central Processing Unit (CPU) 132, a memory cache 134, and a bus interface 138, is operatively coupled via a system bus 142 to a main memory 144 and an I/O control unit 146. The I/O interface control unit is operatively coupled via I/O local bus 148 to a disk storage controller 150, a video controller 152, a keyboard controller 156, and a communications device 160. The communications device is adapted to allow software objects hosted by the general purpose computer to communicate via a network with other software objects. The disk storage controller is operatively coupled to a disk storage device 162. The video controller is operatively coupled to a video monitor 164. The keyboard controller is operatively coupled to a keyboard 166. A network controller 168 is operatively coupled to a communications device 170. The system has I/O expansion slots 172 to accommodate future upgrades.

Computer program instructions implementing loan origination, processing and approval criteria utilizing real estate broker as a primary interface to the transaction are stored on the disk storage device until the microprocessor retrieves the computer program instructions and stores them in the main memory. The microprocessor then executes the computer program instructions stored in the main memory to implement the network based loan origination, processing and approval system.

The architecture of system 10 as well as various components of system 10 are exemplary only. Other architectures are possible and can be utilized in connection with practicing the processes described below.

Loan Processing System (LPS) 10, a fully integrated on-line web-based system, is a centralized and integrated business tool created to drive business accountability and performance, and to improve closing of the loans in a timely manner. LPS 10 utilizes the Internet to increase communication. LPS 10 not only makes loan delivery more accessible but, it also makes the lending process faster, more reliable, efficient and profitable. LPS 10 reduces production costs, lowers fees to borrowers, and allows real estate brokers or appropriately licensed individuals or entities to get paid in compliance with state and federal regulations. LPS 10 is secure, exclusive and protected. Real estate broker or appropriately licensed individual or entity are sometimes referred to as “broker” herein.

The LPS is designed specifically to include the broker in the loan origination process, since broker's license allows the broker to participate in brokering loans for real estate. The business entity provides the processing know-how to offer the best available loan and, a streamlined electronic approval to benefit the broker's client while paying the broker the mortgage origination commission in full compliance with Section 8 of the Real Estate Settlement Procedure Act (RESPA).

In accordance with the present invention, the system and method for loan processing utilizing the real estate broker involves two separate types of agreements. The first type of the agreement known as a Mortgage Broker Agreement, is between the business entity and a real estate broker. The Mortgage Broker Agreement is drafted in compliance with RESPA and to clearly define the broker's responsibilities. The Mortgage Broker Agreement defines the division of the labor in loan processing between lenders-brokers or brokers-brokers to allow for RESPA compliant payments to brokers. The agreement further defines sub-areas of coverage to include various implementations of task divisions between the parties. The sub-areas of coverage further includes the use of the Internet, task lists, help files, and the upload of various documents to complete the tasks. The Mortgage Broker Agreement between the business entity and the real estate broker would include, for example, the following types of provisions:

1. Business Relationship. Real estate broker, or appropriately licensed individual or entity (hereinafter “Broker”) shall, from time to time, submit residential mortgage loan applications to Lender (hereinafter “Lender”) and, as set forth herein, provide additional related services. Following the submission by Broker to Lender of a loan application, Lender shall inform Broker of the particular loan program applicable to such loan. Based upon the loan program that is assigned by Lender to such loan application, and after Lender performs certain additional mortgage-related services with respect to such loan, Lender may, in accordance with the terms of this Agreement, either (a) fund and close such loan in Lender's name (the “Lender-to-Broker Arrangement”) or (b) assign the loan package to a third party for funding and closing (the “Broker-to-Broker Arrangement”).

2. Broker Services. Broker agrees to perform those services related to the origination of residential mortgage loans that, from time to time, have been agreed upon and identified by the parties (the “Services”). With regard to any loan application that will be processed pursuant to a Broker-to-Broker Arrangement, Broker shall perform those specific services indicated on Exhibit A attached hereto. Broker shall deliver to Lender all documents, materials and other items (the “Loan Packages”) related to Broker's performance of the Services, in accordance with the requirements hereof and the guidelines and procedures of Lender, as such guidelines and procedures may be established from time to time by Lender. Broker shall assign all right, title and interest in and to each Loan Package to Lender. The decision to reject or to approve a loan in connection with any Loan Package shall be made by Lender (in the case of a loan processed pursuant to a Broker-to-Broker Arrangement) or by the applicable third party lender (in the case of a loan processed pursuant to a Lender-to-Broker Arrangement), and, in either case, in Lender's or such lender's sole discretion. Lender shall have no obligation or liability for any refusal by Lender or a third party lender to make a loan, or for any delay by Lender or a third party lender in underwriting or closing any loan.

3. Fees. For performing the Services (or such additional or fewer services as may be agreed upon by the parties from time to time), Broker will be paid a fee for each Loan Package that results in a closed residential mortgage loan. The fee shall represent the fair market compensation for all Services actually performed by Broker in the marketplace in which they are provided, and shall be in the amount determined in accordance with the pricing schedule agreed between the parties (in the case of a loan processed pursuant to a Broker-to-Broker Arrangement) or the rate sheet to be provided to Broker by Lender from time to time (in the case of a loan processed pursuant to a Lender-to-Broker Arrangement). The parties understand and agree that this fee is in compensation for services actually performed by Broker. No portion of this fee is paid for the referral of any settlement service business, or is a split or percentage of any charge made or received by either party with respect to any loan. In addition, in the event that Broker performs any other services in connection with the loan or the real property that will secure such loan, this fee shall be paid only for services that are actual, necessary and distinct from the primary services provided by Broker.

4. Representations and Warranties. Broker represents and warrants that on each date that Broker delivers a Loan Package to Lender and on the closing date of each loan: (a) Broker is duly qualified, licensed and approved to transact business and to conduct the activities contemplated by this Agreement in all states in which such qualification, licensure and approval is required; (b) this Agreement constitutes a legal, valid, binding and enforceable obligation of Broker; (c) the information contained in each Loan Package is true, accurate and complete; (d) there is no circumstance or condition with respect to the related applicant, his or her credit standing, the Loan Package or the underlying property that reasonably can be expected (i) to cause the FHA, VA or a private mortgage insurance company to regard the loan as not eligible for insurance or guaranty, (ii) to cause Fannie Mae, Freddie Mac or a private investor to regard the loan as an unacceptable investment or not eligible for resale, (iii) to cause the loan to become delinquent or (iv) to adversely affect the value or marketability of the loan; (e) Broker is the sole owner of each Loan Package free and clear of all liens and encumbrances, and has the authority to sell and assign the Loan Package on the terms set forth herein; and (f) each Loan Package was originated and all Services were performed by Broker in accordance with, and in satisfaction of, all applicable federal, state and local laws and all other requirements and guidelines of Lender (as may from time to time be prescribed) and all relevant investors, agencies and insurers.

5. Compliance. On the date hereof and on each anniversary hereof, Broker shall deliver to Lender a copy of all of Broker's licenses and approvals that are required or appropriate in connection with the performance by Broker of the Services hereunder. Within ninety (90) days after the close of its fiscal year, Broker shall provide Lender with its audited financial statements, which statements must include a computation of Broker's adjusted net worth that has been prepared in accordance with applicable law and requirements. Broker agrees to fully cooperate with and assist Lender in obtaining any additional information and documentation that Lender deems necessary in order to further process and, as appropriate, underwrite and close any loan and to otherwise accomplish the transactions contemplated hereunder. Broker shall not represent to any applicant or other person that any loan has been approved, or will be approved and/or funded, until such time as Broker is so informed by Lender. All appraisals must accurately reflect the value of the subject property, be prepared by a licensed appraiser and listed on Lender's then-current approved appraiser roster. Broker shall obtain from each loan applicant or other person for whom home financing is or may be sought, and Broker shall cause each such person to execute, a written authorization (substantially in the form of the “Borrower's Certification & Authorization” set forth on Lender's web site) in which the applicant or such other person expressly consents to Lender obtaining his or her credit report or credit history from a credit reporting agency or other appropriate source; Broker shall maintain all such written authorizations and, upon Lender's request, make them available or deliver them to Lender.

6. Termination. This Agreement may be terminated by either party for any reason at any time. If Lender terminates this Agreement based upon any material breach of this Agreement or of any other agreement, understanding or arrangement between Broker and Lender, then Lender shall have no obligation to further process or, in the case of a loan processed pursuant to a Lender-to-Broker Arrangement, close any loan submitted by Broker to Lender hereunder, regardless of whether a commitment has been issued prior to delivery of the notice of termination. Termination of this Agreement shall not relieve either party of any liability to the other party for any damages or other amounts due hereunder. The provisions of Sections 6, 7, 8 and 9 hereof shall survive any termination of this Agreement.

7. Indemnification; Repurchase. Broker shall indemnify and hold Lender harmless from any damage, loss or expense (including attorneys fees and all costs of investigation, defense, settlement and appeal) (collectively, “Damages”) directly or indirectly arising from (i) the non-performance of any obligation or covenant, or the breach or inaccuracy of any representation or warranty, of the Broker hereunder, (ii) any third party claim involving the Loan Package or any of the Services (including, without limitation, claims by an applicant or third party lender), or (iii) any acts or omissions of the Broker or its employees or agents, regardless of whether such acts or omissions were willful, negligent or otherwise. In addition, in the event that Lender has received a written request to repurchase any loan with respect to which Broker performed any Services, and the basis for such repurchase request relates in whole or in part to any act or omission by Broker, then Lender shall have the right, at its election, to either (i) repurchase and then foreclose upon or re-sell the related loan or the mortgaged property, or (ii) require Broker to wire to Lender the funds necessary to repurchase the loan immediately following Broker's receipt of notice from Lender and Lender shall thereafter assign such loan to Broker; in either event, Broker shall indemnify Lender for any related Damages. Broker's obligations under this Section shall be fully applicable regardless of whether Lender has accepted the Loan Package, reviewed the Loan Package, or underwritten or closed the related loan. The parties agree that Lender shall be entitled to recovery of all Damages and that any full credit bid at a foreclosure sale shall not be used in determining Damages, nor shall any evidence of a full credit bid by Lender be admissible at any proceeding, trial, arbitration or mediation.

8. Right of Offset. In the event that Broker owes any amount to Lender hereunder or under any other agreement, understanding or arrangement between Broker and Lender, then Lender shall have the right, without notice, to deduct any and all of such amounts from amounts that otherwise would be payable hereunder by Lender to Broker.

9. Disclosure Requirements. With regard to each loan that is processed pursuant to a Broker-to-Broker Arrangement, Broker will provide a written disclosure (the “Borrower Disclosure”), to all mortgage loan applicants. Broker shall ensure that each such disclosure is signed by Broker and each mortgage loan applicant.

10. Record Storage. Broker agrees to maintain and act as custodian of the Original Credit Documents (including executed Loan application, Mortgage loan disclosures, Authorization to release credit information, and other documents requested from time to time by Lender) until such time as Lender directs Broker to deliver the Original Credit Documents to Lender or to destroy such document. Broker shall provide Lender with copies of all Original Credit Documents via facsimile. Broker shall segregate and maintain custody and control of Original Credit Documents on behalf of Lender. Broker warrants that Original Credit Documents will not be altered from their original form. Broker warrants that it shall keep all information contained with Original Credit Documents confidential. Broker shall immediately deliver and relinquish custody and control to Lender of any and all Original Credit Documents upon request.

11. Miscellaneous. Broker shall have no right, power or authority, express or implied, to (i) approve a loan application, orally or in writing, (ii) bind Lender or any other third party, without Lender's or such third party's prior written approval, to any rate quote or rate lock, or (iii) issue to prospective mortgagors any type of binding commitment to loan funds on behalf of Lender or any other third party. No Loan Package submitted by Broker hereunder shall relate to a loan that is intended to be insured by the FHA or guaranteed by the VA. This Agreement shall be governed by the laws of California (excluding its choice of laws principles). Failure to insist upon strict compliance with any of the terms, covenants or conditions hereof at any time shall not be deemed a waiver of such term, covenant or condition at any other time nor shall any waiver of any right herein at any time be deemed a waiver of the same or any other right at any other time. The parties are completely independent of one another and this Agreement shall not be construed to create any partnership, employment or other affiliation between the parties.

The second type of the agreement is between the borrower and the licensed loan officer/real estate broker (the “Borrower Disclosure”). The Borrower Disclosure is made to the borrower in full compliance with state and federal regulations. It is also a material consideration of the loan transaction. The Borrower Disclosure is made to all parties involved in the listing, purchase/sale, and financing of real property. The broker referred to in the Borrower Disclosure is a real estate broker or a licensed loan officer. The Borrower Disclosure between the borrower (hereinafter “Borrower”) and the broker/licensed loan officer (hereinafter “Broker”) would include, for example, the following provisions:

1. Any representations made for the purpose of listing, purchase/sale or financing of real property are not made and shall not be considered made by, through or on behalf of Lender (hereinafter “Lender”), its agents, servants, or employees.

In particular, any representations made by Broker, or its agents, servants or employees on Broker's behalf and concerning the subject property are made solely as an agent of Borrower and are never made by or on behalf of Lender, its agents, servants or employees in any manner. Such representations include, but are not limited to, representations regarding: loan terms; purchase and sale of real property; quality of the property; soils; foundational or construction defects; environmental hazards; building permits or lack thereof; real estate description, use, future use, zoning, repairs or conditions. Broker is without authority to bind Lender in any manner whatsoever. In addition, Broker is without authority to direct or control Lender in any manner related to the terms, listings, description, offers, counter-offers, purchase, sale, closing, financing or refinancing of the real property in any manner.

2. The parties are notified that Broker is preparing documents to submit to Lender, on behalf of the borrower, solely for the purpose of originating mortgage loans in connection with the financing of the real property, and Broker is not authorized in any manner to make any representations concerning the real property, for any reason or purpose whatsoever, on behalf of Lender.

3. In addition to the commission received by Broker from the sale/purchase of the real property and in the event a mortgage loan is obtained and facilitated through Broker's efforts, Broker also will receive a commission based upon services performed by Broker on behalf of the borrower in preparing the loan package. Broker shall not receive any commission for mortgage loans insured by FHA.

The parties hereto acknowledge, by their signature, that Lender, its agents, servants, and employees are not liable for any representations made by any person involving the financing, purchase or sale of real property as set forth in Paragraph 1 and forever waive their rights to bring any form of lawsuit, litigation or arbitration or mediation against Lender, its agents, servants or employees involving such representations, including but not limited to all rights to pursue civil litigation and arbitration.

4. If any part of this agreement shall be found by a court of competent jurisdiction to be invalid, illegal, or unenforceable, such provision shall be construed and enforced as if it had been more narrowly drawn so as not to be invalid, illegal or unenforceable, and the validity, legality and enforceability of the remainder provisions of this agreement shall not in anyway be affected or impaired thereby.

5. All parties to this agreement have drafted the terms herein and in cases of uncertainty of ambiguity of terms, this agreement is to be interpreted as if drafted by all parties and the meaning is to be ascertained by fair inferences from all other terms in the agreement.

6. The parties whose signatures appear below acknowledge that this agreement is a material consideration of the loan transaction submitted to Lender, and this disclosure will be a part of each loan package submitted to Lender.

As stated above, LPS 10 eliminates the need of a traditional loan agent and helps manage the loan transaction by putting the broker in direct communication with the loan processor. LPS 10 further avoids the duplication. LPS 10 facilitates the transaction with the help of a broker to represent his client in accordance with RESPA (federal) guidelines. The broker processes the paperwork with the help of LPS 10, while the business entity's support staff shops for the best available loan among hundreds of products, and processes it to a successful close. The restructuring of the business responsibility and accountability creates a stronger bond between broker and client, expedites the loan process, and offers the buyer various loan choices. However, before the broker can process the loan through the system, the broker is required to sign up utilizing LPS 10 which also includes executing the Mortgage Broker Agreement and the Borrower Disclosure. LPS 10 further reduces production costs, lender fees to borrower and allow broker to be paid in compliance with state and federal regulations.

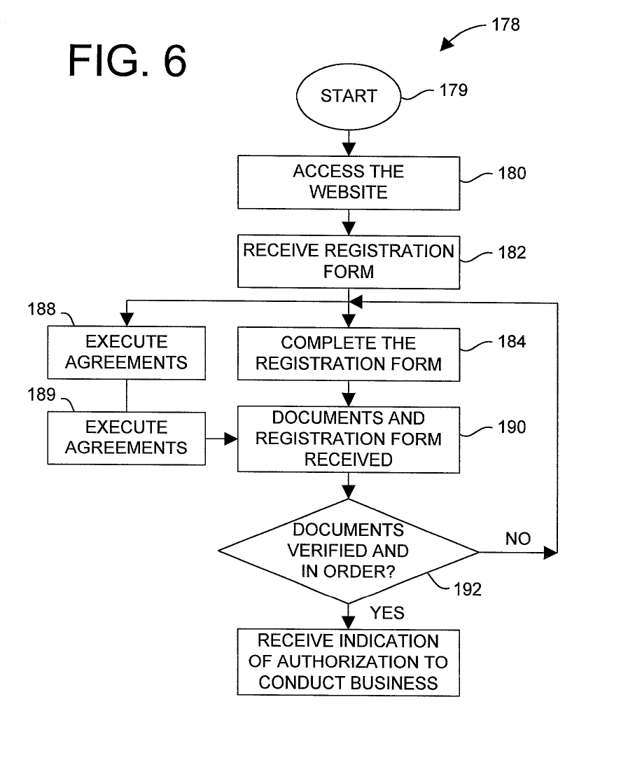

FIGS. 5 and 6, as described below, are exemplary embodiments of data flow diagrams of the LPS depicting the functionality of the system. These flow charts identify the process steps as utilized by the user. The flow charts also depict the overall relationship among various individuals involved in loan processing within and outside the business entity.

FIG. 6 is an exemplary embodiment of a Broker Registration Process flowchart 178 in accordance with the present invention. The user starts 179 the process of registration by accessing 180 the web site. Once the user enters the web site, the user receives 182 the registration form provided by server 12. The registration form permits the user to register with the business entity utilizing LPS 10. The registration form provides the user with an option to sign up as a “Broker” or as a “Sales Person”. The registration form includes input for a unique identification name or number of the office and a password. The user completes 184 a form by providing general contact information, e.g., full name, mailing address, telephone number, e-mail address and so on, to register the user. Once the user has completed the form, the user transmits the form back to server 12 by selecting a “send” (not shown) button at a pre-determined position on the registration form user interface. Simultaneously, the user executes 188 the Mortgage Broker Agreement and forwards 189 the agreement with a copy of the broker license to the business entity. Once the documents are received 190 and verified 192 by the representative of the business entity, an indication is received authorizing 194 to conduct the business. If the documents or the agreements are not executed according to the business entity's guidelines as set forth on the web site, an indication is sent to correct the problem or re-execute the contract. Before the authorization is issued, the representative of the business entity ensures that the contract signed by the licensed person or the broker is in full compliance with the RESPA. Section 8 of RESPA prohibits so called “kickbacks” and “referral fees” but does permit payment of fees to a licensed person that performs certain actual, necessary and distinct work on the loan transaction. LPS 10 ensures full compliance with state and federal regulations and is designed with checks and balances to ensure that the system's functionality is not circumvented by users or other employees within the business entity. The types of agreements that are executed by the parties are the Mortgage Broker Agreement and the Borrower Disclosure, as discussed above.

Once the user transmits the information, the broker contact information record is assigned an information ID by server 12 (shown in FIG. 2). The information ID allows server 12 to quickly identify and retrieve the associated broker contact information record. The information ID is a unique number or key that points to the broker information within the user registration form. A date stamp is also attributed to the user information provided through the user registration record. Initially, the date stamp designates a date and time upon the creation of the registration record. The date stamp is updated upon each update of the broker contact information record. The broker receives an ID for the office. Salespersons employed by the broker use the ID received by the broker to identify their association with the broker. In an exemplary embodiment of the invention, an individual ID's for the broker as well as individual sales people are possible for tracking purposes.

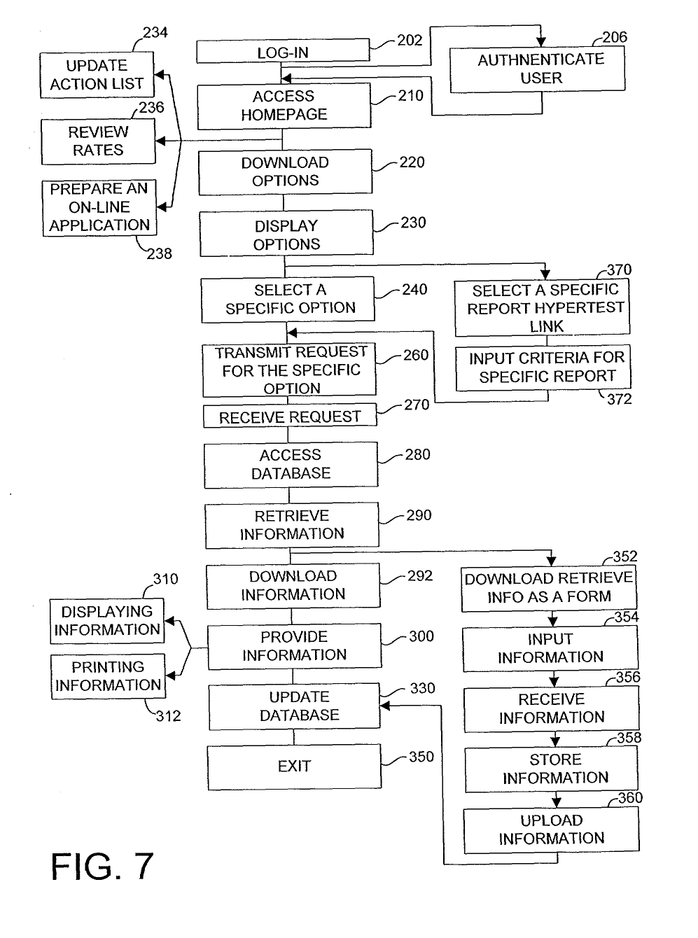

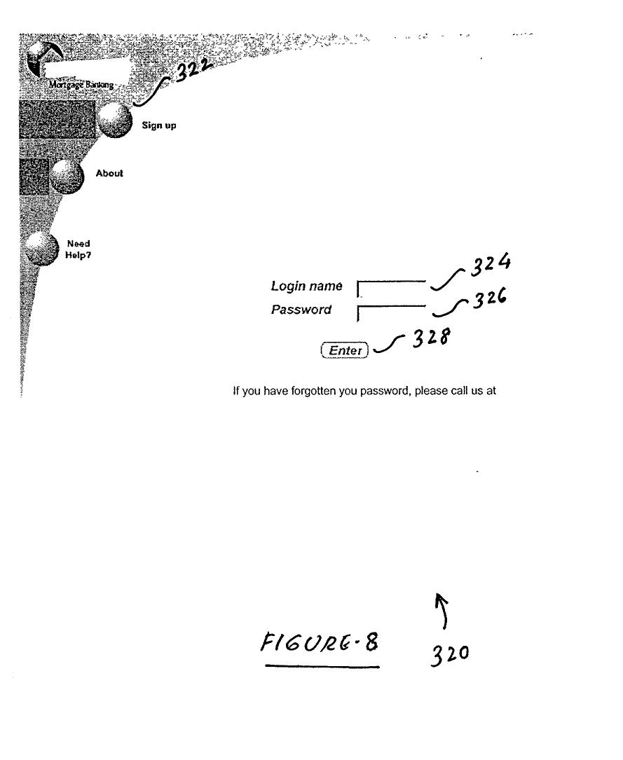

FIG. 7 is an exemplary embodiment of a flowchart 200 depicting Business Process Flow. Through a welcome screen (shown in FIG. 8), a user, who is normally a broker or his designated representative, having an authorized access, accesses the system by logging 202 on to system 10 (shown in FIG. 2) with a user ID and a password. Once the user has been authenticated 206 based on the user ID and the password, the user is provided access 210 to the system.

Under the web-based system 10, the user accesses 210 home page of the web site through client system 14 (shown in FIG. 2). Server system 12 (shown in FIG. 2) downloads 220 and displays 230 several options. In an exemplary embodiment, after the user has been authenticated the user is provided access to Update Action List 234 on a specific transaction, Review Rates 236, or Prepare an On Line Application 238.

Once the user selects 240 a specific option out of various hypertext links, the request is transmitted 260 to server system 12. Transmitting 260 the request is accomplished either by click of a mouse or by a voice command. Once server system 12 receives 270 the request, server system 12 accesses 280 the database server 16 and retrieves 290 pertinent information from database 20 (shown in FIG. 2). The requested information is downloaded 292 and provided 300 to client system 14. Server system 12 provides 300 the requested information to the user by either displaying 310 the information on the user's display or by printing 312 it on an attached or a remote printer. The user continues to search database 20 for other information, updates 330 database 20 with new or revised information or exits 350 from system 10.

In another embodiment of the invention, the retrieved 290 information is downloaded as a “Form” 352 to help the user to input/submit information 354 in a specified format regarding a loan transaction. The inputted information 354 is received 356 by server system 12 for storing 358 in database 20. The user also updates 330 the database by adding, deleting or modifying the information regarding the loan transaction. The user updates databases by uploading 360 the revised information to server system 12. For example, once the user has completed a specific task, the user uploads 360 the new document or updated version of the old document to server system 12. The user further has an option to revise and update 330 the task list depending on the progress he has made on the transaction.

In yet another embodiment, the home page displays several options identified above and also displays the options for retrieving various management reports. If the user wishes to obtain management reports, the user may obtain the reports by selecting 370 a specific hypertext link. Once the user selects 370 a hypertext link, the user then inputs 372 criteria/parameters of the report and transmits 260 a request to the server system by selecting a submit button (not shown). Transmitting 260 the request directs server system 12 to retrieve 290 the data from centralized database 20 (shown in FIG. 2) and provides 300 the data to the user on the user's interface in a pre-determined format.

In a further embodiment, client system 14, as well as server system 12, are protected from access by unauthorized individuals. As described, LPS 10 is an interactive searchable database 20 for all loans/transactions related information and provides flexibility to users, business executives as well administrators of LPS 10 to stay current with the related information to-date. The system provides the ability for managers, employees and database administrators to directly update, review and generate reports of current as well as past loan transactions.

FIGS. 8 through 13 are exemplary embodiments of screen displays depicting the LPS functionality. These various embodiments describe one specific way of practicing invention, displaying data or printing reports. However, one skilled in the art would recognize that there are multiple possible combinations of organizing the data, displaying the data on the screen as well as printing the data in various reporting formats which still express the same essential matter and process steps.

FIG. 8 is an exemplary embodiment of a home page 320 welcoming the user to the business entity's web site. By selecting a hypertext link “Sign Up” 322, the user accesses the sign up segment of the web site to sign up with the business entity to conduct the business. FIG. 6 above describes the registration process in detail. From home page 320, the user is prompted to enter a user identification (i.e. Login Name) 324 and a password 326 associated with the user identification. Once the user submits the data by pressing an enter button 328, LPS 10 authenticates the user before providing the access. LPS 10 is a secured system. There is often a specific security on a document-by-document basis. The site in the present embodiment can be utilized as an intranet as well as across various networks over the Internet. In other embodiment, the password utilized by the LPS is case sensitive and requires that it be matched completely before the user is provided access to the system.

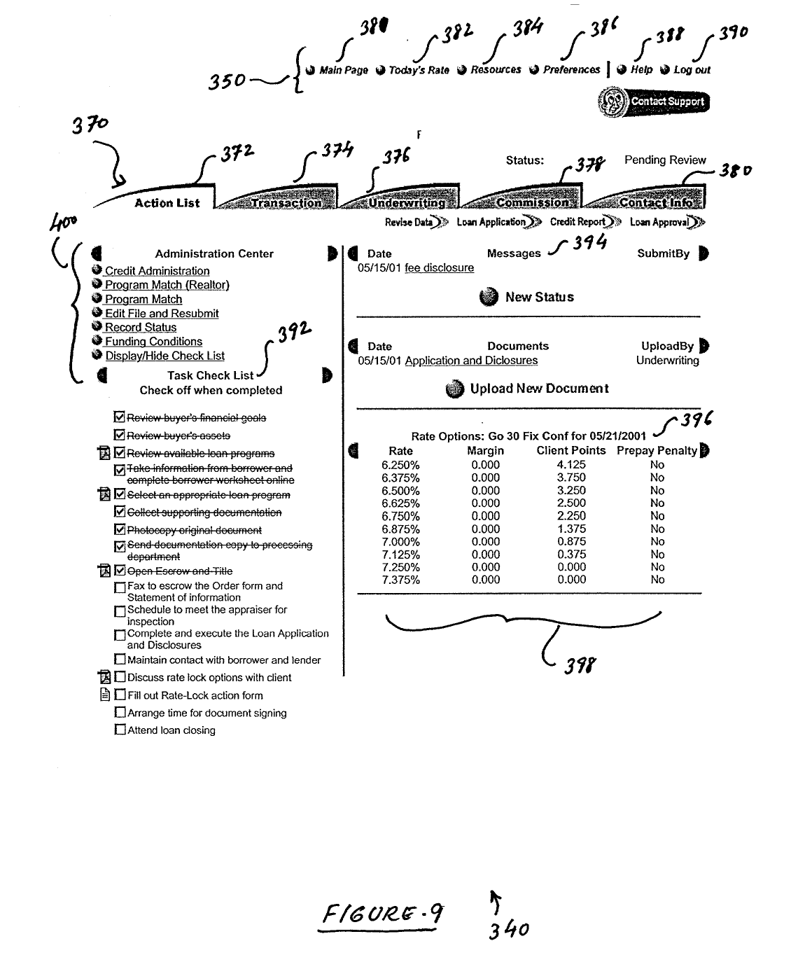

FIG. 9 is an exemplary embodiment of a web-based screen 340 providing the information to a user regarding a specific loan transaction. Screen 340 is downloaded by server system 12 (shown in FIG. 2) on to client system 14 (shown in FIG. 2) when the user selects a specific transaction. In this instance, screen 340 displays details regarding a buyer name “Randolph LeRoy” who is purchasing a property located at 4487 Colbath. Screen 340 further provides a quick overview regarding the status of the current loan application and a number of days required to close the escrow.

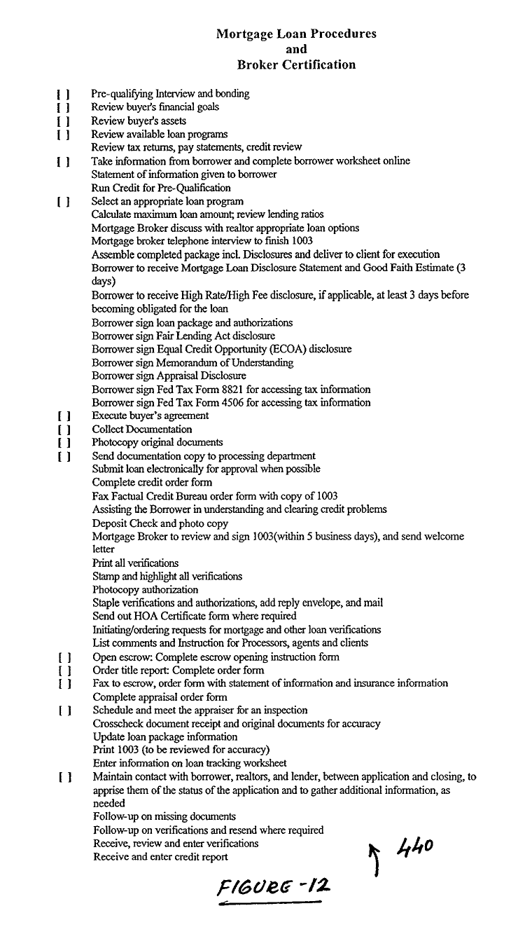

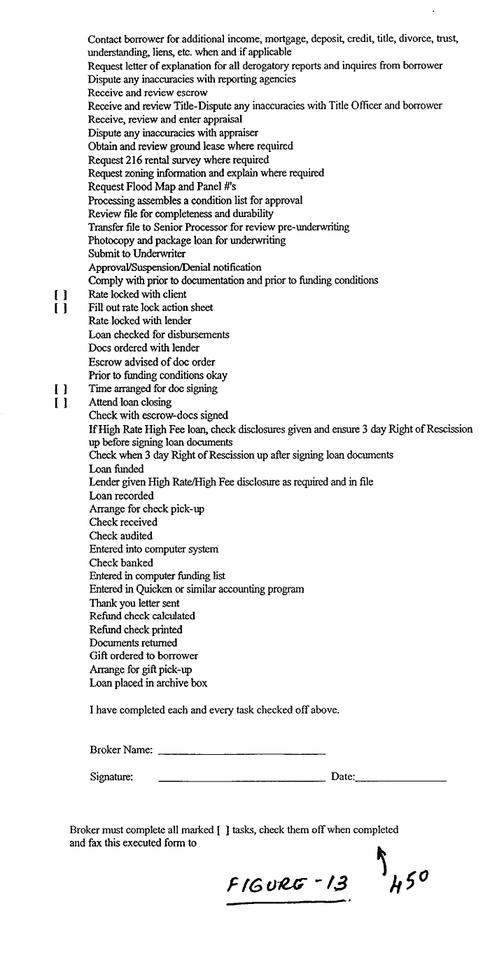

Screen 340 is utilized for creating and updating details of a transaction as well as for facilitating navigation within the web site. FIG. 9 identifies action buttons 350, section tabs 370 and sub-sections under each section tabs. Action buttons 350 appear at the top of every screen as the user navigates through a specific transaction document. The system is designed to interact directly through these buttons. The user navigates through these buttons to return to the home page, cancel changes, save changes, and upload or submit documents. Section tabs 370 identify the various tabs utilized by the system to organize the data. For example, in an exemplary embodiment, the section tabs are, an Action List tab 372, a Transaction tab 374, an Underwriting tab 376, a Commission tab 378, and an Contact Information tab 380. Action buttons 350 are: a Main Page button 381, a Today's Rate button 382, a Resources button 384, a Preferences button 386, an Help button 388 and a Log Out button 390. Sub-sections under Action List tab 372 include, for example, a Revise Data sub-section, a Loan Application sub-section, a Credit Report sub-section, and a Loan Approval sub-section. The LPS offers a vast amount of information to be captured for each transaction. The transaction is split into various different logical sections to permit the user to retrieve the information on any specific section by selecting a specific section tab at the top of each transaction. For example, Action List tab 372 provides expanded level of information regarding various task check lists 392 that are being undertaken by the broker, and status of these action items to-date. Task check list 392, is further elaborated in FIGS. 12 and 13 (below). In an exemplary embodiment, task check list 392, which defines broker's responsibility, includes, reviewing buyer's financial goals, reviewing buyer's assets, reviewing available loan programs, reviewing tax returns, income statements, credit review, taking information from borrower and completing borrower worksheet online, selecting an appropriate loan program, collecting documentation, photocopying original documents, sending documentation copy to processing department, opening escrow, completing escrow opening instruction form, ordering a title report, completing order form, faxing to escrow the order form with statement of information and insurance information if applicable, scheduling and meeting the appraiser for an inspection, maintaining contact with borrower, realtors, and lender, to apprise them of the status of the application and to gather additional information, locking the rate with the client, if necessary, preparing rate lock action sheet processing, arranging time for document signing, and attending loan closing. The broker prioritizes items from the check list, completes the items, and checks of the items from the check list 392 as they are completed.

Underwriting tab 376, for example provides detailed information pertaining to the progress of a transaction from the underwriting department's perspective. Commission tab 378 provides an overview of the commission earned or the commission anticipated on the transaction. Each of these tabs provides a valuable information, including, but not limited to, messages 394 that are currently received from various individuals as they pertain to that transaction, various rate options 396 and other pertinent details 398. In one embodiment, up to the minute rate options are provided to brokers and other authorized users accessing the system. Web-based screen 340 further provides various hypertext links 400 to facilitate access to various sections of the administration center.

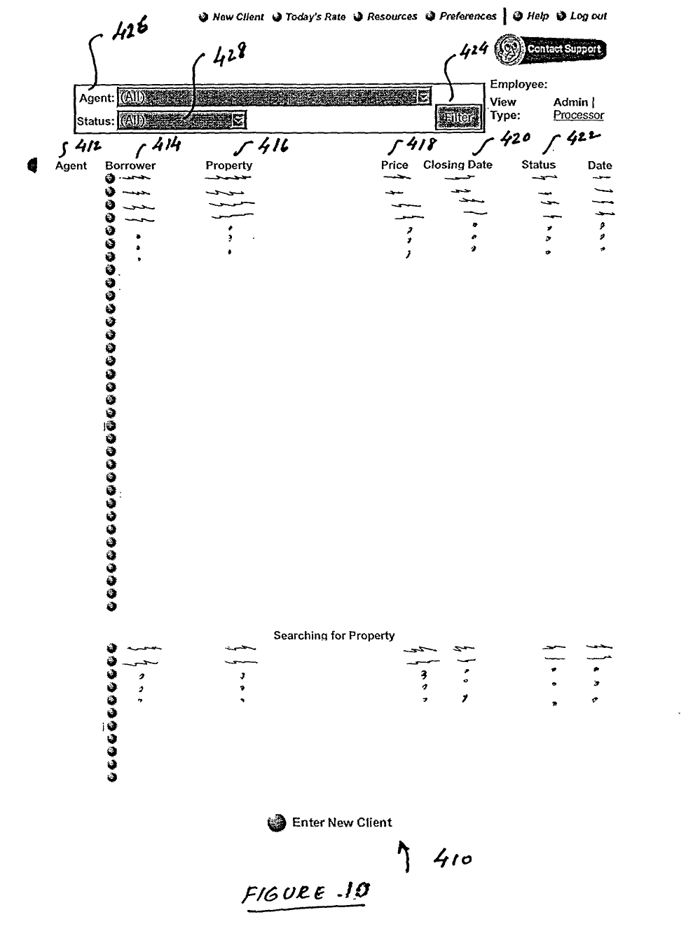

FIG. 10 is an exemplary embodiment of a report 410 downloaded by the LPS system for a specific employee. Report 410 is sorted by an agent 412, a borrower 414, a property address 416, a price 418 of the property, a closing date 420 of the loan transaction, and a status 422 of the loan. Report 410 provides various filter options 424 such as a name of the employee 426, or a status 428 of the loan. LPS 10 provides flexibility to print or display various other reports.

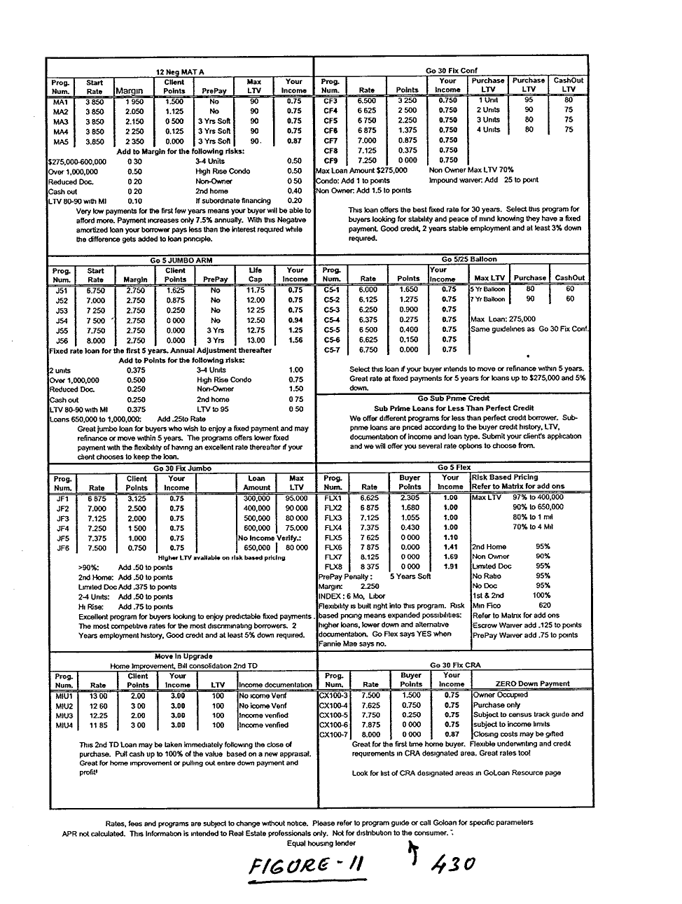

FIG. 11 is an exemplary embodiment of a mortgage rates report 430 downloaded by the LPS system to provide detail rate information to various brokers that are registered to use the LPS system.

FIG. 12 is an exemplary embodiment of a Mortgage Loan Procedures & Broker Certification Report 440 downloaded by the LPS system, which must be completed and submitted by the broker before any commission is paid to the broker. Report 440 identifies the responsibilities undertaken by the broker. The responsibilities undertaken by the broker are also identified under task check list 392 (shown in FIG. 9, above). In an exemplary embodiment, the lender maintains the task list. In yet another embodiment, the broker maintains the task list. It is also feasible that a third party may maintain the task list for the broker or the lender for a small fee, or the task list is tracked automatically by the technology as soon as documents status is entered into LPS 10. Report 440 is executed by the broker in compliance with RESPA and faxed to the administrator of the business entity. Report 440 is required to comply with various state and federal regulations. FIG. 13 is a continuation page 450 of the mortgage loan procedures of Broker Certification Report 440.

While the invention has been described in terms of various specific embodiments, those skilled in the art will recognize that the invention can be practiced with modification within the spirit and scope of the claims.

What is claimed is:

1. A method for loan origination, processing and approval, using a network based system including a server system coupled to a centralized database and at least one client system, said method comprising:
establishing a business relationship pertaining to a loan transaction between a broker and a lender through legal agreements;
defining a division of labor through a task list between the broker and the lender to assist in the performance of the legal agreements;
providing forms and informational notices in support of the task list; and
maintaining the task list to ensure that the broker has complied with the task list.

2. A method according to claim 1 wherein said step of establishing a business relationship further comprises the step of executing at least one of a mortgage broker agreement and a borrower disclosure agreement.

3. A method according to claim 1 wherein said step of defining a division of labor through a task list further comprises the step of identifying at least one of a task as the broker responsibility out of:
a) Reviewing buyer's financial goals,
b) Reviewing buyer's assets,
c) Reviewing available loan program,
d) Reviewing tax returns, pay statements, credit review,
e) Taking information from borrower and completing borrower worksheet online,
f) Selecting an appropriate loan program,
g) Collecting Documentation,
h) Photocopying original documents,
i) Sending documentation copy to processing department,
j) Opening escrow,
k) Completing escrow opening instruction form,
l) Ordering tile report,
m) Completing order form,
n) Faxing to escrow the order form with statement of information and insurance information,
o) Completing appraisal order form,
p) Scheduling and meeting the appraiser for an inspection,
q) Maintaining contact with borrower, realtors, and lender, between application and closing to apprise them of the status of the application and to gather additional information, as needed,
r) Locking the rate with the client,,
s) Preparing rate lock action sheet processor,
t) Arranging time for document signing, and
u) Attending loan closing.

4. A method according to claim 1 wherein said step of providing forms and informational notices further comprises downloading forms and informational notices on the client system.

5. A method according to claim 4 wherein said step of downloading further comprises the steps of:
accessing the centralized database;
searching the database regarding a specific inquiry;
retrieving information from the database; and
transmitting the retrieved information to the client system for display by the client system.

6. A method according to claim 4 wherein said step of downloading further comprises the steps of downloading the user manual from the server system and printing the downloaded manual on a printer.

7. A method according to claim 4 wherein said step of downloading further comprises the step of uploading forms and informational notices to the server system after they are completed by the broker.

8. A method according to claim 1 wherein said step of maintaining the task list further comprises the step of auditing the task list with original documents to ensure compliance to state and federal regulations.

9. A method according to claim 1 further comprising the steps of:
processing the loan transaction in compliance with state and federal regulations;
approving the loan transaction;
funding the loan transaction; and
issuing a commission check to the broker pursuant to the legal agreements after the loan transaction has been funded.

10. A method according to claim 1 wherein said step of step of maintaining the task list further comprises printing requested information in a pre-determined format.

11. The method according to claim 1 wherein the client system and the server system are connected via a network and wherein the network is one of a wide area network, a local area network, an intranet and the Internet.

12. A method for loan origination, processing and closing, using a network based system including a server system coupled to a centralized database and at least one client system, said method comprising:
originating a loan application by a licensed individual;
processing the loan application by a lender through a task list that defines a division of labor between the licensed individual and the lender,
maintaining the task list to ensure that the broker and the lender have complied with their responsibilities; and
closing the loan application in compliance with state and federal regulations.

13. A system for managing loan transaction in compliance with federal and state regulations, said system comprising:
a client system comprising a browser;
a data storage for storing information;
at least one server system configured to be coupled via a network to said client system and said data storage device, said server system further configured to:
develop and track a task list to implement a division of labor between a broker and a lender relating to activities resulting in funding of a loan for a real property transaction;
provide an indication to a party responsible for the task on the task list;
process an approval of the loan after all tasks on the task list are completed and regulatory requirements are satisfied; and
issue a commission check to the broker upon funding of the loan and closing of the real property transaction.

14. A system according to claim 13 wherein said client system is further configured with:
a displaying component for displaying a variety of options to a user; and
a sending component to send an inquiry to the server system so that the server system can process and download the requested information to the client system.

15. A system according to claim 14 wherein the sending component functions in response to a click of a mouse button.

16. A system according to claim 14 wherein the sending component functions in response to a voice command.

17. A system according to claim 13 wherein said client system is further configured to be protected from access by unauthorized individuals.

18. A system according to claim 13 wherein said server system is configured to send automatic e-mail notifications to parties involved.

19. A computer to facilitate online origination, processing and approval of loans, said computer coupled to a centralized database and programmed to:
receive loan transaction information in to the centralized database;
store the loan transaction information into various subsections of the centralized database and cross reference the loan transaction information against a borrower identification for easy retrieval and update;
evaluate the loan transaction based on pre-determined criteria; and
generate management reports to track the loan transaction.

20. The computer according to claim 19 further programmed to provide a notification to users via electronic mail regarding final decision.

21. The computer according to claim 19 further programmed to provide flexibility to an administrator to make changes to the centralized database by at least one of adding, modifying and deleting the loan transaction information.

22. A computer program embodied on a computer readable medium for processing and approving real estate loans, comprising a code segment providing for:
registering a broker with a lender to process a loan transaction;
providing a list of tasks and targeted completion dates to the broker based on an anticipated closing date of the loan transaction;
tracking the list against the targeted completion dates to complete the task;
generating loan documents after the loan transaction has been approved; and
generates a commission check to the broker after the loan documents are executed and the loan transaction is closed.

23. The computer program as recited in claim 22 wherein registering the broker with lender is accomplished on line.

24. The computer program as recited in claim 22 further includes a code segment for prioritizing the task list.

25. The computer program as recited in claim 22 further includes a code segment for generating various management reports based on a user selected criteria in a pre-determined format to track loan transactions.

26. The computer program as recited in claim 22 further includes a code segment for monitoring the security by restricting access to unauthorized individuals.

27. A database to manage loan processing and improve operational efficiency of a business entity, said database comprising:
data corresponding to various transactions with at least one of transactions status data and action lists data associated with various transactions;
data corresponding to various mortgage programs with at least one of associated referenced numbers, a starting rate and an ending rate, a margin, client points, and maximum loan to value ratio; and
data corresponding to contact information regarding parties to various transactions, the data corresponding to contact information cross referenced against data corresponding to various mortgage programs and data corresponding to various transactions for at least one of easy retrieval, update and storage.

28. A database according to claim 27 further comprising data corresponding to at least one of borrowers, agents, properties, a price of each property, a closing date of each property, and a status of a loan transaction for each property.

29. A database according to claim 27 further comprising data corresponding to borrowers preferences for products and services.

30. A database according to claim 27 further comprising data corresponding to brokers preferences for products and services.

31. A database according to claim 27 further comprising data corresponding to negative history of at least one of brokers and borrowers.

32. A database according to claim 27 further comprising at least one of data corresponding various mortgage rates, data corresponding various risk assessment criteria, and data corresponding various loan applications, wherein the data corresponding various mortgage rates and the data corresponding various risk assessment criteria, are cross referenced to data corresponding various loan applications.
